(19) United States
(12) Patent Application Publication
(10) Pub. No.: US 2025/0231347 A1
(43) Pub. Date: Jul. 17, 2025

(54) TAPERED MODE TRANSFORMER

(71) Applicant: University of Central Florida Research Foundation, Inc., Orlando, FL (US)

(72) Inventor: Guifang Li, Orlando, FL (US)

(21) Appl. No.: 19/019,079

(22) Filed: Jan. 13, 2025

Related U.S. Application Data
(60) Provisional application No. 63/620,399, filed on Jan. 12, 2024.

(51) Int. Cl. G02B 6/30

(52) U.S. Cl. CPC G02B 6/305

(57) ABSTRACT

A mode transformation device may include a tapered waveguide having a first face and a second face separated along a guiding direction, where a cross-section of the tapered waveguide at the first face comprises an arrangement of three or more guiding structures, and where the three or more guiding structures include at least a first guiding structure surrounded by a second guiding structure surrounded by third guiding structure. A cross-sectional dimension of at least one of the three or more guiding structures adiabatically changes along the guiding direction such that light propagating through the tapered waveguide has a first optical mode profile at the first face and a second optical mode at the second face, where the light transitions from the first optical mode profile to the second optical mode profile as it propagates along the guiding direction.

### CROSS-REFERENCE TO RELATED APPLICATION

The present application claims the benefit under 35 U.S.C. § 119 (e) of U.S. Provisional Application Ser. No. 63/620,399, filed Jan. 12, 2024, entitled TAPERED MODE TRANSFORMER, naming Guifang Li as inventor, which is incorporated herein by reference in the entirety.

### TECHNICAL FIELD

The present disclosure is directed generally to optical mode transformers and, more particularly, to a tapered mode transformer.

### BACKGROUND

Many optical devices incorporate waveguides formed from semiconductor materials. It is often desirable to couple light from such waveguides into optical fibers. However, optical mode mismatches due to the size and/or shape differences result in undesirable coupling losses. Typical techniques for addressing this problem such as spot size converters attempt to match the mode size to increase coupling, but typically still provide elliptical mode profiles and thus still suffer from losses.

There is therefore a need to develop systems and methods to address the above deficiencies.

### SUMMARY

In embodiments, the techniques described herein relate to a mode transforming device including a tapered waveguide having a first face and a second face separated along a guiding direction, where a cross-section of the tapered waveguide at the first face includes an arrangement of three or more guiding structures, where the three or more guiding structures include at least a first guiding structure surrounded by a second guiding structure surrounded by third guiding structure, where a cross-sectional dimension of at least one of the three or more guiding structures adiabatically changes along the guiding direction, where light propagating through the tapered waveguide has a first optical mode profile at the first face and a second optical mode profile at the second face, where the light transitions from the first optical mode profile to the second optical mode profile as it propagates along the guiding direction.

In embodiments, the techniques described herein relate to a mode transforming device, where the light propagates from the first face to the second face.

In embodiments, the techniques described herein relate to a mode transforming device, where the light propagates from the second face to the first face.

In embodiments, the techniques described herein relate to a mode transforming device, where the first guiding structure extends to the second face.

In embodiments, the techniques described herein relate to a mode transforming device, where the first guiding structure terminates prior to the second face.

In embodiments, the techniques described herein relate to a mode transforming device, where the first guiding structure operates as a guiding core for the first optical mode profile, where a different one of the three or more guiding structures operates as the guiding core for the second optical mode profile.

In embodiments, the techniques described herein relate to a mode transforming device, where a refractive index of the first guiding structure is higher than a refractive index of the second guiding structure, where the refractive index of the second guiding structure is higher than a refractive index of the third guiding structure.

In embodiments, the techniques described herein relate to a mode transforming device, where the first guiding structure, the second guiding structure, and the third guiding structure are formed from a common material with at least one of different dopants or different levels of a common dopant.

In embodiments, the techniques described herein relate to a mode transforming device, where the first guiding structure, the second guiding structure, and the third guiding structure are formed from different materials.

In embodiments, the techniques described herein relate to a mode transforming device, where the first guiding structure has a rectangular cross-sectional shape, where the second guiding structure and the third guiding structure have circular cross-sectional shapes.

In embodiments, the techniques described herein relate to a mode transforming device, where the first optical mode profile is elliptical, where the second optical mode profile is circular.

In embodiments, the techniques described herein relate to a mode transforming device, where the first guiding structure is formed from a semiconductor material, where at least one other of the three or more guiding structures are formed from glass.

In embodiments, the techniques described herein relate to a mode transforming device, where the three or more guiding structures include at least four guiding structures, where the light transitions through one or more intermediate optical mode profiles between the first optical mode profile and the second optical mode profile.

In embodiments, the techniques described herein relate to an optical device including an optical waveguide providing light at an output face with a first optical mode profile; and a tapered waveguide having a first face and a second face separated along a guiding direction, where the output face of the optical waveguide is coupled with the first face of the tapered waveguide, where a cross-section of the tapered waveguide at the first face includes an arrangement of three or more guiding structures, where the three or more guiding structures include at least a first guiding structure surrounded by a second guiding structure surrounded by third guiding structure, where a cross-sectional dimension of at least one of the three or more guiding structures adiabatically changes along the guiding direction, where the light propagating through the tapered waveguide has the first optical mode profile at the first face and a second optical mode profile at the second face, where the light transitions from the first optical mode profile to the second optical mode profile as it propagates along the guiding direction.

In embodiments, the techniques described herein relate to an optical device, further including an additional waveguide coupled to the second face of the tapered waveguide and configured to couple the light with the second optical mode profile.

In embodiments, the techniques described herein relate to an optical device, where the optical waveguide includes a semiconductor device, where the additional waveguide includes an optical fiber.

In embodiments, the techniques described herein relate to an optical device, where the first guiding structure extends to the second face.

In embodiments, the techniques described herein relate to an optical device, where the first guiding structure terminates prior to the second face.

In embodiments, the techniques described herein relate to an optical device, where the first guiding structure operates as a guiding core for the first optical mode profile, where a different one of the three or more guiding structures operates as the guiding core for the second optical mode profile.

In embodiments, the techniques described herein relate to an optical device, where the three or more guiding structures include at least four guiding structures, where the light transitions through one or more intermediate optical mode profiles between the first optical mode profile and the second optical mode profile.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram view of a mode transforming device, in accordance with one or more embodiments of the present disclosure.

FIG. 2 illustrates a perspective view of a mode transforming device, in accordance with one or more embodiments of the present disclosure.

FIG. 3 illustrates a cross-sectional view of a first face of the mode transforming device of FIG. 2, in accordance with one or more embodiments of the present disclosure.

FIG. 4 illustrates a cross-sectional view of a second face of the mode transforming device of FIG. 2, in accordance with one or more embodiments of the present disclosure.

FIG. 5 illustrates a block diagram view of an optical device that includes a mode transforming device, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing mode transformation and/or coupling between waveguides of different shapes and/or sizes. In embodiments, a mode transforming device includes a tapered waveguide with a first face and a second face separated by a guiding direction, where a cross-sectional profile of the tapered waveguide includes an arrangement of three or more guiding structures (e.g., at least a first guiding structure, a second guiding structure surrounding the first guiding structure, a third guiding structure surrounding the second guiding structure, and so on). Further, one or more cross-sectional dimensions of the tapered waveguide may adiabatically change (e.g., decrease or increase) along the guiding direction from the first face to the second face.

A mode transforming device may provide unidirectional and/or bidirectional coupling between light with a first optical mode profile at the first face and a second optical mode profile at the second face. Put another way, light may propagate between the first and second faces in any direction.

As a nonlimiting illustration, light received through the first face may be initially guided with the first guiding structure (e.g., a central guiding structure) operating as a core with the second and/or third guiding structures operating as a cladding. As the light propagates along the tapered waveguide, the optical mode profile of the light will undergo a lossless transition (or at least a transition having an optical loss lower than a selected threshold) from a first optical mode profile at or near the first face to a second optical mode profile at or near the second face. In this configuration, the light may gradually decouple from the first guiding structure and instead be guided with the second guiding structure operating as a core and the third guiding structure operating as a cladding. In cases where the tapered waveguide includes more than three guiding structures, the optical mode profile may transition through one or more intermediate optical mode profiles between the first output optical mode profile and the output optical mode profile.

It is contemplated herein that the systems and methods disclosed herein may provide lossless coupling between waveguides of any sizes or dimensions. As a non-limiting example, the size and/or shape of the first guiding structure may be configured to efficiently receive light from an external planar waveguide (e.g., a semiconductor waveguide, or the like), while the sizes and/or shapes of the second and third guiding structures (as well as additional guiding structures) may be configured to efficiently couple light from the second face to an optical fiber. As another non-limiting example, the tapered waveguide may provide lossless coupling of light into a polarization-maintaining optical fiber.

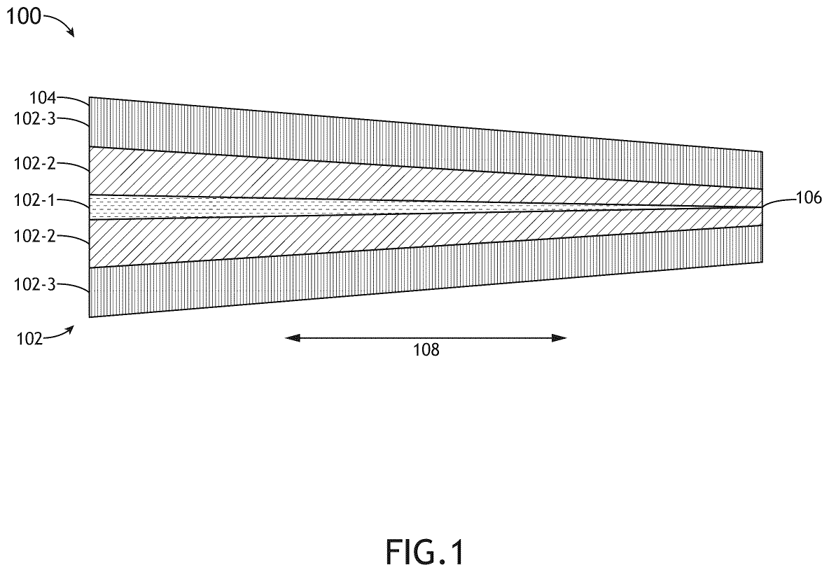

Referring now to FIGS. 1-4, a mode transforming device 100 is described in greater detail, in accordance with one or more embodiments of the present disclosure.

FIG. 1 illustrates a block diagram view of a mode transforming device 100, in accordance with one or more embodiments of the present disclosure.

In embodiments, a mode transforming device 100 is formed as a tapered waveguide having three or more guiding structures 102 suitable for guiding light between a first face 104 and a second face 106 unidirectionally and/or bidirectionally, where cross-sectional dimensions of the three or more guiding structures 102 normal to a guiding direction 108 adiabatically change (e.g., decrease or increase) along the guiding direction. In particular, FIG. 1 depicts a configuration with three guiding structures 102: a first guiding structure 102-1, a second guiding structure 102-2, and a third guiding structure 102-3.

It is contemplated herein that such a mode transforming device 100 may allow for the lossless coupling of light from the first guiding structure 102-1 to the second guiding structure 102-2 due to the adiabatic taper. It is further contemplated herein that the arrangement of guiding structures 102 of the mode transforming device 100 at or near the first face 104 may be designed to provide efficient input coupling of light having a first optical mode profile (e.g., size and/or distribution of light), whereas the arrangement of guiding structures 102 of the mode transforming device 100 at or near the second face 106 may be designed to provide a different optical mode profile (e.g., a different size and/or distribution of light).

The various guiding structures 102 may have any shapes and may be formed from any materials suitable for providing desired optical mode profiles and the first face 104 and second face 106. As a result, the mode transforming device 100 may facilitate efficient coupling between optical devices of different sizes and/or shapes.

As an illustration, the mode transforming device 100 may be designed to provide efficient coupling between a planar waveguide (e.g., a semiconductor waveguide, or the like) and an optical fiber, which is desirable for many applications. For example, many planar waveguides have rectangular cross-sectional shapes such that output light is elliptical, whereas optical fibers typically have circular cores. Further, planar waveguides are typically smaller than the cores of optical fibers, which further contributes to mode mismatch and inefficient coupling between such devices. While a spot size converter may help expand the beam size of light from a planar waveguide to improve matching, typical spot size converters have rectangular or square profiles and thus cannot provide ideal coupling to an optical fiber. However, a mode transforming device 100 as disclosed herein may provide efficient coupling between such a planar waveguide and an optical fiber through efficient coupling with the planar waveguide at the first face 104 and lossless transformation of the optical mode profile to provide efficient coupling with an optical fiber at a second face 106.

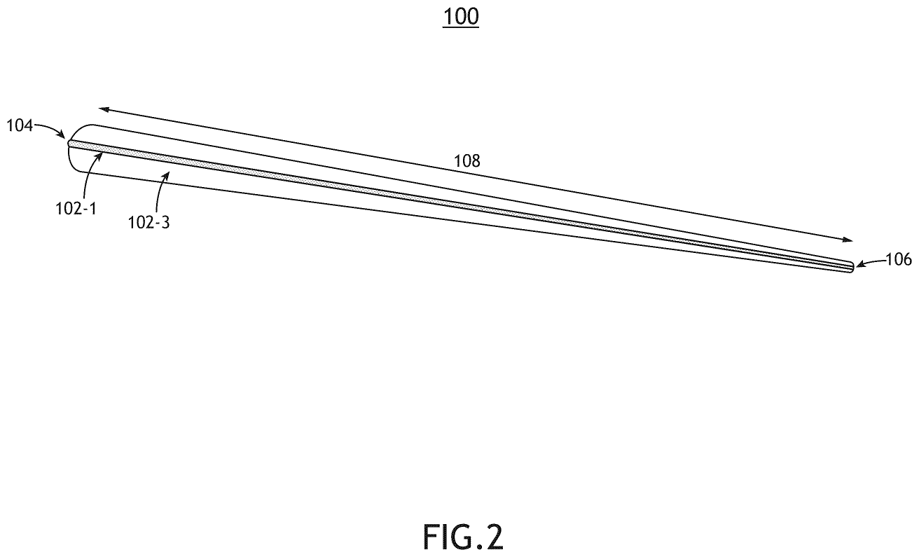

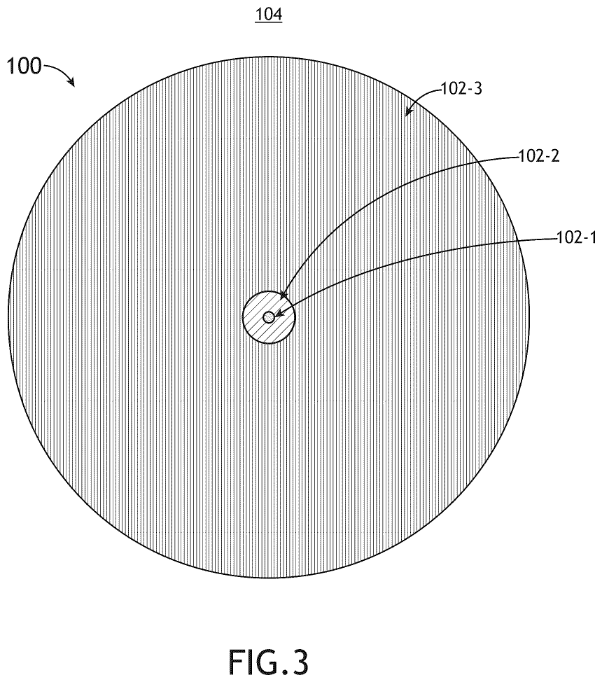

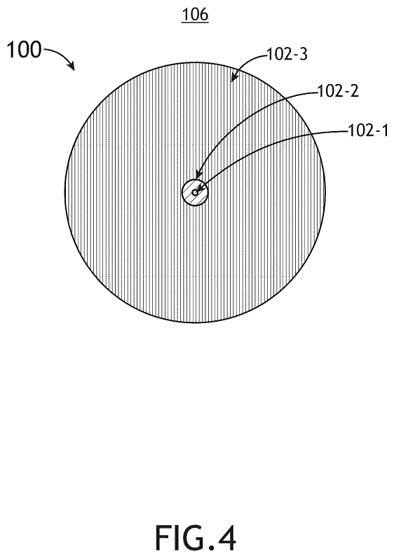

FIGS. 2-4 illustrate one non-limiting configuration of a mode transforming device 100, in accordance with one or more embodiments of the present disclosure. FIG. 2 illustrates a perspective view of a mode transforming device 100, in accordance with one or more embodiments of the present disclosure. FIG. 3 illustrates a cross-sectional view of a first face 104 of the mode transforming device 100 of FIG. 2, in accordance with one or more embodiments of the present disclosure. FIG. 4 illustrates a cross-sectional view of a second face 106 of the mode transforming device 100 of FIG. 2, in accordance with one or more embodiments of the present disclosure.

As illustrated in FIG. 3, the first face 104 of the mode transforming device 100 includes an arrangement of three guiding structures in cross-section: a first guiding structure 102-1 (e.g., a center guiding structure), a second guiding structure 102-2 surrounding the first guiding structure 102-1, and a third guiding structure 102-3 surrounding the second guiding structure 102-2. It is noted that the third guiding structure 102-3 is not shown in the perspective view of FIG. 2 for clarity of illustration, but is present. Further, the refractive indices of the guiding structures 102 may be highest in the center and may successively decrease away from the center. For example, the refractive index of the first guiding structure 102-1 may be higher than the refractive index of the second guiding structure 102-2, which may be higher than the refractive index of the third guiding structure 102-3 (and so on in the case of more guiding structures 102). Different refractive indices may be achieved using any technique. For example, the first guiding structure 102-1, second guiding structure 102-2, and third guiding structure 102-3 may be formed from different materials. As another example, the first guiding structure 102-1, second guiding structure 102-2, and third guiding structure 102-3 may be formed from a common material but may have different doping characteristics. For instance, the first guiding structure 102-1, second guiding structure 102-2, and third guiding structure 102-3 may have different dopants and/or different levels of a common dopant.

Such a configuration may provide a first optical mode profile for light at or near this first face 104 in which the first guiding structure 102-1 operates as a core while the second guiding structure 102-2 operates as a cladding. The third guiding structure 102-3 may also operate as a cladding, though this is not a requirement. In some applications, virtually no light may propagate in the third guiding structure 102-3 near the first face 104.

In the case of light coupled into the first face 104 and propagating towards the second face 106, the gradually reducing cross-sectional dimensions of the guiding structures 102 will result in a gradual decoupling of the light out of the first guiding structure 102-1 such that it may instead be guided primarily in the second guiding structure 102-2. At this point, the second guiding structure 102-2 may operate as a core and the third guiding structure 102-3 may operate as a cladding. The size, shape, and material properties of the second guiding structure 102-2 and the third guiding structure 102-3 may then provide a second optical profile at the second face 106 that differs from the first optical profile at the first face 104.

As one non-limiting illustration, the mode transforming device 100 may be configured to provide efficient coupling between a planar waveguide and an optical fiber. For example, the first guiding structure 102-1 may have an elliptical and/or rectangular cross-sectional shape and may further be sized similarly to dimensions of an expected external planar waveguide. In this way, light from the planar waveguide may efficiently couple into the first face 104 of the mode transforming device 100. Put another way, the mode transforming device 100 may support a first optical mode profile near the first face 104 that matches well with an optical mode profile supported by the planar waveguide to promote efficient input coupling. The cross-sectional size and/or shape of the second guiding structure 102-2 and the third guiding structure 102-3 may then be selected to provide a second optical mode profile near the second face 106 that is suitable for efficient coupling with the optical fiber. For example, the second guiding structure 102-2 and the third guiding structure 102-3 may have circular cross-sectional shapes. Further, the second guiding structure 102-2 may be designed such that the cross-sectional diameter at the second face 106 is matched to that of an optical fiber to provide efficient coupling to the optical fiber.

It is to be understood, however, that FIGS. 2-4 are provided solely for illustrative purposes and should not be interpreted as limiting the scope of the present disclosure. It is contemplated herein that a mode transforming device 100 as disclosed herein may be configured to provide lossless coupling between any selected optical mode profiles and thus provide efficient coupling between any input and output optical devices.

The mode transforming device 100 may generally include any number of guiding structures 102 at the first face 104 and is not limited to three as illustrated in FIGS. 2-3. For example, the mode transforming device 100 may include at least four guiding structures 102. It is contemplated herein that a mode transforming device 100 providing more than three guiding structures 102 may enable gradual transitions through any number of intermediate optical mode profiles. For example, in a case where the first and second optical mode profiles are too dissimilar to allow lossless transitioning through adiabatic tapering over a reasonable length, additional guiding structures 102 may provide a more controlled transition.

Further, it is not necessary that all of the guiding structures 102 fully extend from the first face 104 to the second face 106. For example, adiabatic tapering may result in vanishingly small cross-sectional dimensions of at least the first guiding structure 102-1. Put another way, at least the first guiding structure 102-1 may terminate prior to the second face 106.

Any particular one of the guiding structures 102 may have any cross-sectional shape such as, but not limited to, circular, elliptical, triangular, rectangular, square, pentagonal, hexagonal, and so on. Further, any particular guiding structure 102 may be formed from any material or combination of materials such as, but not limited to, semiconductor, glass, ceramic, or polymer. As an illustration, it may be desirable to fabricate the first guiding structure 102-1 in FIGS. 2-3 from a semiconductor material such as, but not limited to, silicon to facilitate efficient coupling with a silicon waveguide. Further, the second guiding structure 102-2 and the third guiding structure 102-3 may be fabricated from different materials such as, but not limited to, silica or other glasses (doped or undoped) to provide efficient coupling with traditional optical fibers.

The mode transforming device 100 may couple with external devices using any technique known in the art. Further, in some embodiments, the first face 104 and/or the second face 106 may be integrated with one or more external devices. As an illustration, the second face 106 of the mode transforming device 100 may be spliced with an optical fiber to form a fully-integrated device.

The mode transforming device 100 may further be configured to provide coupling between any types of devices and is not limited to providing coupling between devices of different shapes and/or sizes. In some embodiments, the mode transforming device 100 provides efficient coupling between a waveguide mode and a polarization-maintaining fiber in either direction.

The mode transforming device 100 may further operate in either direction. For example, the terms first face 104 and second face 106 are merely illustrative herein and it is recognized that a mode transforming device 100 may receive light through the second face 106 of FIGS. 2-4 and output light through the first face 104 of FIGS. 2-4. Further, it is not necessary that the first face 104 be larger than the second face 106. In some embodiments, one or more cross-sectional dimensions decrease from the second face 106 to the first face 104.

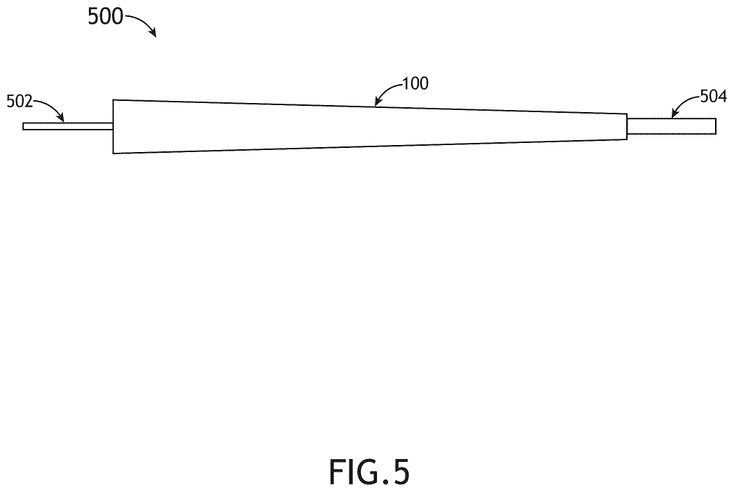

Referring now to FIG. 5, FIG. 5 illustrates a block diagram view of an optical device 500 that includes a mode transforming device 100, in accordance with one or more embodiments of the present disclosure.

In some embodiments, an optical device 500 includes a first waveguide 502 providing a first optical mode profile and a mode transforming device 100 coupled to the first waveguide 502 and configured to manipulate the light from the first optical mode profile to a second optical mode profile.

The first waveguide 502 may have any design and may be formed from any materials. For example, the first waveguide 502 may be formed as a semiconductor waveguide, an optical fiber, or any other waveguide type. Further, the first waveguide 502 may be associated with any type of device such as, but not limited to, a light source (e.g., a waveguide-coupled laser source, a fiber-coupled laser source) or a photonic integrated circuit (PIC) device.

The optical device 500 may optionally include a second waveguide 504 configured to receive the light from the mode transforming device 100 having the second optical mode profile. In a case in which the second waveguide 504 is not present, light emanating from the mode transforming device 100 may correspond to output light from the optical device 500. In this configuration, the mode transforming device 100 may provide light with a desired optical mode that may be different from an associated light source. In cases in which the second waveguide 504 is present, the mode transforming device 100 may provide efficient mode coupling between the first waveguide 502 and the second waveguide 504.

The second waveguide 504 may also have any design and may be formed from any materials. For example, the second waveguide 504 may be formed as a semiconductor waveguide, an optical fiber, or any other waveguide type. Accordingly, the mode transforming device 100 may provide efficient mode coupling between any two waveguides and associated devices.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A mode transforming device comprising:
a tapered waveguide having a first face and a second face separated along a guiding direction, wherein a cross-section of the tapered waveguide at the first face comprises an arrangement of three or more guiding structures, wherein the three or more guiding structures include at least a first guiding structure surrounded by a second guiding structure surrounded by third guiding structure, wherein a cross-sectional dimension of at least one of the three or more guiding structures adiabatically changes along the guiding direction, wherein light propagating through the tapered waveguide has a first optical mode profile at the first face and a second optical mode profile at the second face, wherein the light transitions from the first optical mode profile to the second optical mode profile as it propagates along the guiding direction.

2. The mode transforming device of claim 1, wherein the light propagates from the first face to the second face.

3. The mode transforming device of claim 1, wherein the light propagates from the second face to the first face.

4. The mode transforming device of claim 1, wherein the first guiding structure extends to the second face.

5. The mode transforming device of claim 1, wherein the first guiding structure terminates prior to the second face.

6. The mode transforming device of claim 1, wherein the first guiding structure operates as a guiding core for the first optical mode profile, wherein a different one of the three or more guiding structures operates as the guiding core for the second optical mode profile.

7. The mode transforming device of claim 1, wherein a refractive index of the first guiding structure is higher than a refractive index of the second guiding structure, wherein the refractive index of the second guiding structure is higher than a refractive index of the third guiding structure.

8. The mode transforming device of claim 7, wherein the first guiding structure, the second guiding structure, and the third guiding structure are formed from a common material with at least one of different dopants or different levels of a common dopant.

9. The mode transforming device of claim 7, wherein the first guiding structure, the second guiding structure, and the third guiding structure are formed from different materials.

10. The mode transforming device of claim 1, wherein the first guiding structure has a rectangular cross-sectional shape, wherein the second guiding structure and the third guiding structure have circular cross-sectional shapes.

11. The mode transforming device of claim 10, wherein the first optical mode profile is elliptical, wherein the second optical mode profile is circular.

12. The mode transforming device of claim 10, wherein the first guiding structure is formed from a semiconductor material, wherein at least one other of the three or more guiding structures are formed from glass.

13. The mode transforming device of claim 1, wherein the three or more guiding structures include at least four guiding structures, wherein the light transitions through one or more intermediate optical mode profiles between the first optical mode profile and the second optical mode profile.

14. An optical device comprising:
an optical waveguide providing light at an output face with a first optical mode profile; and
a tapered waveguide having a first face and a second face separated along a guiding direction, wherein the output face of the optical waveguide is coupled with the first face of the tapered waveguide, wherein a cross-section of the tapered waveguide at the first face comprises an arrangement of three or more guiding structures, wherein the three or more guiding structures include at least a first guiding structure surrounded by a second guiding structure surrounded by third guiding structure, wherein a cross-sectional dimension of at least one of the three or more guiding structures adiabatically changes along the guiding direction, wherein the light propagating through the tapered waveguide has the first optical mode profile at the first face and a second optical mode profile at the second face, wherein the light transitions from the first optical mode profile to the second optical mode profile as it propagates along the guiding direction.

15. The optical device of claim 14, further comprising an additional waveguide coupled to the second face of the tapered waveguide and configured to couple the light with the second optical mode profile.

16. The optical device of claim 15, wherein the optical waveguide comprises a semiconductor device, wherein the additional waveguide comprises an optical fiber.

17. The optical device of claim 14, wherein the first guiding structure extends to the second face.

18. The optical device of claim 14, wherein the first guiding structure terminates prior to the second face.

19. The optical device of claim 14, wherein the first guiding structure operates as a guiding core for the first optical mode profile, wherein a different one of the three or more guiding structures operates as the guiding core for the second optical mode profile.

20. The optical device of claim 14, wherein the three or more guiding structures include at least four guiding structures, wherein the light transitions through one or more intermediate optical mode profiles between the first optical mode profile and the second optical mode profile.
